(19) United States
(12) Patent Application Publication
(10) Pub. No.: US 2017/0138384 A1
(43) Pub. Date: May 18, 2017

(54) METHOD AND SYSTEM FOR SETTING A SELF-CUTTING UNDERCUT ANCHOR

(71) Applicant: Harald Goettlich, Wedemark (DE)

(72) Inventor: Harald Goettlich, Wedemark (DE)

(73) Assignee: UIP UNIVERSAL INNOVATIVE PRODUCTS GMBH & CO. KG, Mainaschaff (DE)

(21) Appl. No.: 13/261,698

(22) PCT Filed: Dec. 14, 2011
(86) PCT No.: PCT/EP11/06293

§ 371 Date: Apr. 23, 2015

(30) Foreign Application Priority Data
Jan. 25, 2011 (EP) 11000567.5

(51) Int. Cl. F16B 13/08

(52) U.S. Cl. CPC F16B 13/0816

(57) ABSTRACT

The invention relates to a method and system for setting a self-cutting the undercut anchor in an anchor base.

This invention relates to a method and a system for setting an undercut anchor.

In the field of structural engineering, we are often faced with the task of anchoring to elements such as concrete or reinforced concrete. For this purpose, various fixings are known, which can be divided depending on their mechanism and the type of power transmission.

In heavy-duty fixings, there are basically two types of mechanical anchors. Some are called expansion anchors and hold to the anchor base by friction. Other anchors are form-fitting; those are called undercut anchors.

In the publication “Qualification of Post-Installed Mechanical Anchors in Concrete and Commentary” of the American Concrete Institute, ISBN 978-0-87031-247-2, First Printing June 2007, ACI 355.2-07, various mechanical anchors and their variations are described.

The present invention relates to the so-called undercut anchors. A classification of the known methods for setting such undercut anchors can be found in the FIGS. 2.3 a-f in the aforementioned publication in a schematic representation.

A disadvantage of the process for setting an undercut anchor described therein is that a precise bore depth must be maintained and/or that a torque wrench is required and thereby a certain torque must be maintained.

In this context, the present invention seeks to provide a method and a system for setting a self-cutting undercut anchor, which would make a precise bore depth and the use of a torque wrench with a specified torque superfluous. A further object of the invention is to improve a method and a system for setting a self-cutting undercut anchor with respect to the function to be performed, the application area, the feasibility of reducing the risk of injury and the reproducibility. On the whole, a lower-cost method and a system for setting a self-cutting undercut anchor shall be provided. The object of the present invention is also to provide an undercut anchor, which can be easily anchored preferably near the surface, while it can also be used in safety-related areas and should allow anchorages with sufficiently high holding values. Another object of the invention is to provide a method to quickly set the self-cutting undercut anchor in the anchor base, preferably close to the surface, so that a building component or the like can be fitted to the undercut anchor directly after the setting, that is, without delay.

This object is achieved by a method for setting a self-cutting undercut anchor, exhibiting the features characterized in patent claim 1, and by a system for setting a self-cutting undercut anchor, exhibiting the features characterized in patent claim 11. Advantageous embodiments and further developments of the invention are characterized in the dependent claims.

The undercut anchor, required to carry out the method according to the invention, comprises of an expansion sleeve, which is subdivided into expansion tongues by longitudinal slots, arranged in the setting direction in the front part of the expansion sleeve, and which has an internal thread in the setting direction in the rear region. The undercut anchor further comprises of an expansion body, which is arranged inside the expansion sleeve, in the setting direction, in the front region of the expansion sleeve.

According to the invention, the following method steps are provided:
a) Screwing a flanged sleeve into the internal thread of the expansion sleeve, disposed in the rear region in the setting direction
b) Introducing the expansion sleeve into a bore, introduced in the anchor base, in such a way that the flanged sleeve, fastened to the expansion sleeve, is placed with the lower face of the flange on the anchor base, or the upper edge of the bore
c) Inserting a drive-in bolt through the flanged sleeve into the expansion sleeve
d) Driving in the drive-in bolt in the setting direction in such a way that the expansion body is pressed forwards, that is to say deeper into the expansion sleeve, through the end of the drive-in bolt, which is at the front in the setting direction, in such a way that the expansion tongues are expanded for anchoring in the anchor base and cut with the cutting edges into the anchor base
e) Removing the drive-in bolt, or the flange sleeve together with the drive-in bolt, from the expansion sleeve.

Such a method allows a simple installation using the simplest tool of a self-cutting undercut anchor with a guaranteed correct undercut, particularly in safety-relevant areas, while the anchorages achieve sufficiently high holding values. It is advantageous that no precise bore depth is required here. Furthermore, a torque tool with a prescribed torque is not required. Setting the undercut anchor is less time- and therefore cost-consuming.

It may be advantageous, when the process step c) is carried out before step b).

It may be expedient if the introduction of the drive-in bolt through the flanged sleeve according to method step c) is performed before the step a), so that the flanged sleeve and the drive-in bolt then form an assembly tool together, and that subsequently according to method step a) the flanged sleeve with the drive-in bolt is screwed in the inner thread of the expansion sleeve, disposed in the setting direction in the rear part, wherein step c) is then omitted.

It may furthermore be advantageous, when the bolt head of the drive-in bolt rests on the upper side of the flanged sleeve when driving in.

It may also be advantageous when the flanged sleeve, together with the drive-in bolt, or the flanged sleeve after removal of the drive-in bolt, is removed from the expansion sleeve by unscrewing, the collar, whereas the sleeve of the flanged sleeve has for this purpose preferably a tool-gripping section, preferably designed as a hexagon.

A further development of the invention foresees that the bore is drilled in such a way that its length is at least equal to or preferably greater than the length of the expansion sleeve.

It may be advantageous if the undercut anchor is anchored near the surface, so that the rear end of the expansion sleeve in the setting direction essentially extends up to the bore edge.

It may be expedient that, after removal of the drive-in bolt or of the flanged sleeve together with the drive-in bolt, the anchored expansion sleeve is available for further use, preferably for fixing of components, whereby the corresponding fixing elements are screwed into the expansion sleeve.

An advantageous embodiment of the invention foresees that the setting of the undercut anchor occurs at least semi-automatically by way of inserting the undercut anchor, as a unit consisting of an expansion sleeve and an expansion body, integrally with the assembly tool from a flanged sleeve and a drive-in bolt, into the bore, while the drive-in bolt is preferably inserted, and in any case the flanged sleeve is removed, preferably by unscrewing, together with the drive-in bolt from the expansion sleeve, using a machine, preferably a hammer drill with a special extension.

It may be advantageous when the assembly tool of flanged sleeve and drive-in bolt, connected or attached to the machine, is provided with a new expansion sleeve together with a new expansion body after removal from the expansion sleeve, so that a new cycle for setting the self-cutting undercut anchor can ensue.

The invention further relates to a system for setting an undercut anchor in an anchor base, covering
a) an undercut anchor with an expansion sleeve, which is subdivided into expansion tongues by longitudinal slots, arranged in the setting direction in the front part of the expansion sleeve, and which has an internal thread in the setting direction in the rear region, and having an expansion body within the expansion sleeve, disposed in the setting direction in the front region of the expansion sleeve,
b) a flanged sleeve, which has an external thread and can be screwed accordingly into the internal thread of the expansion sleeve and
c) a drive-in bolt, which can be inserted into the expanding sleeve in the setting direction through the flanged sleeve.

An advantageous embodiment of the invention foresees that the drive-in bolt has a bolt head in the rear region in the setting direction, in particular at the rear end.

It may be advantageous, when the sleeve of the flanged sleeve has a tool-gripping section, so that it can be easily screwed into the expansion sleeve.

It may be advantageous, when the bolt head is designed in such a way that, after it has been driven into and fixed on the flange, it shows a marking as evidence of a successful operation.

Furthermore, it may be advantageous if the marks on the lower part of the bolt head are visible grooves.

It may be useful, if the length of the drive-in bolt is selected in such a way that the expansion body is pressed into the expansion sleeve to a predetermined depth in order to spread apart the expansion tongues and to generate an undercut. It is advantageous that the drive-in bolt can be blunt in the setting direction in the front region, in particular on the front end.

It can be expedient, when the shaft of the drive-in bolt is thread-free.

It may be advantageous if the length of the expansion sleeve is 10 mm to 120 mm, preferably, 30 mm to 60 mm.

It may be advantageous if the diameter of the expansion sleeve is 6 mm to 30 mm, preferably 12 mm to 20 mm.

An advantageous embodiment of the invention foresees that the expansion body is made of plastic or metal, preferably steel, or a composite material.

It may be advantageous, when the expansion tongues on the outside of their free ends have at least one, but preferably multiple, ideally three or better still two consecutive cutting edges.

A further development of the invention foresees that the undercut anchor can be used in concrete and reinforced concrete structures, preferably in walls or ideally in ceilings.

It may also be advantageous when an undercut anchor is inserted into a bore from the aforementioned expansion sleeve, together with the expansion body, but without the flanged sleeve, using the drive-in bolt, which can be inserted in the expansion sleeve, in such a way, that the drive-in bolt pushes the undercut anchor up to the bore bottom, or positions the expansion sleeve on the bore bottom, when the drive-in bolt is subsequently driven in the setting direction, in such a way, that the expansion body is pressed forwards, that is to say deeper into the expansion sleeve, by the end of the drive-in bolt, which is at the front in the setting direction, in such a way that the expansion tongues are expanded for anchoring in the anchor base and cut with the cutting edges into the anchor base, and when eventually the drive-in bolt is removed from the expansion sleeve. Preferably, here also the setting of the self-cutting undercut anchor can be semi-automated at least, whereby it is advantageous that a machine with a special extension for receiving and driving the drive-in bolt may be used. Advantageously, it can be a hammer drill with a corresponding extension.

In this way, an undercut anchor can be lowered in a bore, when the load-bearing anchor base is not close to surface.

The invention is hereafter depicted by means of an embodiment in a drawing. Using this method, the system for setting a self-cutting undercut anchor, according to the invention, shall be explained hereafter. Here same reference marks designate the same parts.

According to the invention, the system for setting an undercut anchor 10 in an anchor base 11, comprises
an undercut anchor 10 with an expansion sleeve 12, which is subdivided into expansion tongues 18 by longitudinal slots 14, arranged in the setting direction 16 in the front part of the expansion sleeve 12, and which has an internal thread 20 in the setting direction 16 in the rear region, and having an expansion body 22 within the expansion sleeve 12, disposed in the setting direction 16 in the front region of the expansion sleeve 12,
a flanged sleeve (24), which has an external thread and can be screwed accordingly into the internal thread (20) of the expansion sleeve (12) and
a drive-in bolt (32), which can be inserted into the expanding sleeve (12) in the setting direction through the flanged sleeve (24).

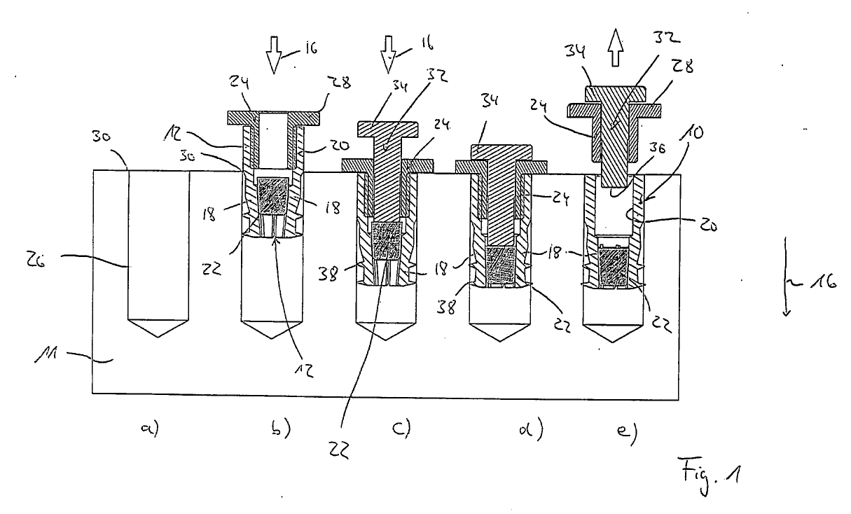

According to the invention, the method for setting a self-cutting undercut anchor comprises, after introducing a bore 26 in the anchor base 11, as shown in a) FIG. 1, the following method steps:
Screwing a flanged sleeve 24 into the internal thread 20 of the expansion sleeve 12 disposed in the rear region in the setting direction 16, and introducing the expansion sleeve 12 into a bore 26 introduced in the anchor base 11 in such a way that the flanged sleeve 24 fastened to the expansion sleeve 12 is placed with the lower face of the flange 28 on the anchor base 11 or the upper edge 30 of the bore 26, as shown in c) FIG. 1,
Inserting a drive-in bolt 32 through the flanged sleeve 24 into the expansion sleeve 12, as shown in c) FIG. 1,
Driving in the drive-in bolt (32) in the setting direction (16), as shown in FIG. 1, in such a way that the expansion body (22) is pressed forwards, that is to say deeper into the expansion sleeve (12), through the end 36 of the drive-in bolt 32, which is at the front in the setting direction 16, in such a way that the expansion tongues 18 are expanded for anchoring in the anchor base 11, and cut with the cutting edges 38 into the anchor base
Removing the flange sleeve 24, together with the drive-in bolt 32, from the expansion sleeve (12) as shown in the FIG. 1.

### LIST OF REFERENCE NUMERALS

### It is Part of the Description

10 Undercut anchor
11 Anchor base
12 Expansion sleeve
14 Longitudinal slots
16 Setting direction
18 Expansion tongues
20 Internal thread
22 Expansion body
24 Flanged sleeve
26 Bore
28 Flange
30 Top edge
32 Drive-in bolt
34 Bolt head
36 Front end
38 Cutting edge

1. A method of setting a self-cutting undercut anchor (10) in an anchor base (11), wherein the undercut anchor (10) includes an expansion sleeve (12), divided into expansion tongues (18) by longitudinal slots (14), which are arranged in the setting direction (16) in the front region of the expansion sleeve (12), and which has an internal thread (20) in the setting direction (16) in the rear region, and wherein the undercut anchor (10) includes an expansion body (22), arranged within the expansion sleeve (12) in the setting direction (16) in the front region of the expansion sleeve (12), having the following method steps:
a) screwing a flanged sleeve (24) into the internal thread (20) of the expansion sleeve (12), disposed in the rear region in the setting direction (16),
b) introducing the expansion sleeve (12) into a bore (26), introduced in the anchor base (11), in such a way that the flanged sleeve (24), fastened to the expansion sleeve (12), is placed with the lower face of the flange (28) on the anchor base (11), or the upper edge (30) of the bore (26),
c) inserting a drive-in bolt (32) through the flanged sleeve (24) into the expansion sleeve (12),
d) driving in the drive-in bolt (32) in the setting direction (16) in such a way that the expansion body (22) is pressed forwards, that is to say deeper into the expansion sleeve (12), through the end (36) of the drive-in bolt (32), which is at the front in the setting direction (16), in such a way that the expansion tongues (18) are expanded for anchoring in the anchor base (11) and cut with the cutting edges (38) into the anchor base (11), and
e) removing the drive-in bolt (32), or the flange sleeve (24) together with the drive-in bolt (32), from the expansion sleeve (12).

2. A method as claimed in claim 1, characterized in that the method step c) is carried out prior to step b).

3. A method as claimed in claim 1, characterized in that the introduction of the drive-in bolt (32) through the flanged sleeve (24), according to method step c), is carried out prior to step a) so that the flanged sleeve (24) and the drive-in bolt (32) together form an assembly tool, and subsequently, as set forth in method step a), the flanged sleeve (24) with drive-in bolt (32) is screwed into the inner thread (20) of the expansion sleeve (12), disposed in the setting direction (16) in the rear part, wherein step c) is then omitted.

4. A method as claimed in claim 1, wherein the bolt head (34) of the drive-in bolt (32) rests on the upper side of the flange (28) of the flanged sleeve (24) when driving in.

5. A method as claimed in claim 1, wherein the flanged sleeve (24) together with the drive-in bolt (32), or the flanged sleeve (24) after removal of the drive-in bolt (32), is removed from the expansion sleeve (12) by unscrewing, whereas the flange (28) of the flanged sleeve (24) is preferably designed as a tool application element, preferably as a hexagon.

6. A method as claimed in claim 1, wherein the bore (26) is drilled so that its length (L) is at least equal to, or preferably greater than, the length (L1) of the expansion sleeve (12).

7. A method as claimed in claim 1, wherein the undercut anchor (10) is anchored near the surface, so that, in the setting direction (10), the rear end of the expansion sleeve (12) essentially terminates at the bore edge (30).

8. A method as claimed in claim 1, wherein after removal of the drive-in bolt (32) or of the flanged sleeve (24) together with the drive-in bolt (32), an anchored expansion sleeve (12) is available for further use, preferably for fixing of components, whereby the corresponding fixing elements are screwed into the expansion sleeve (12).

9. A method as claimed in claim 1, wherein setting the undercut anchor (10) is carried out at least semi-automatically by way of the undercut anchor (10), as a unit consisting of an expansion sleeve (12) and an expansion body (22), integrally with the assembly tool from a flanged sleeve (24) and a drive-in bolt (32), being driven into the bore (26), while the drive-in bolt (32) is preferably inserted, and in any case the flanged sleeve (24) is removed from the expansion sleeve (12), preferably by, unscrewing, together with the drive-in bolt (32) using a machine, preferably a hammer drill with a special extension.

10. A method as claimed in claim 9 characterized in that the assembly tool, connected with the machine or attached to it, composed of flanged sleeve (24) and drive-in bolt (32), is provided with a new expansion sleeve (24) with expansion body (22) after being removed from the expansion sleeve (12), so that a new cycle can be carried out for setting the self-cutting undercut anchor (10).

11. A system for setting an undercut anchor (10) in an anchor base (11), consisting of
a) an undercut anchor (10) with an expansion sleeve (12) which is subdivided into expansion tongues (18) by longitudinal slots (14), arranged in the setting direction (16) in the front part of the expansion sleeve (12), and which has an internal thread (20) in the setting direction (16) in the rear region, and having an expansion body (22) within the expansion sleeve (12), disposed in the setting direction (16) in the front region of the expansion sleeve (12),
b) a flanged sleeve (24), which has an external thread and can be screwed accordingly into the internal thread (20) of the expansion sleeve (12) and
c) a drive-in bolt (32) which can be inserted into the expanding sleeve (12) in the setting direction through the flanged sleeve (24).

12. A system as claimed in claim 11, characterized in that the drive-in bolt (32) a bolt head (34) in the setting direction (16) in the rear region, in particular at the rear end.

13. A system as claimed in claim 11, wherein the flange (28) of the flanged sleeve (24) has a section for gripping a tool, so that the flanged sleeve (24) can be easily screwed into and out of the expansion sleeve (12).

14. A system as claimed in claim 11, wherein the bolt head (24) is designed in such a way that, after it has been driven into and fixed on the flange, it shows a marking as evidence of a successful operation.

15. A system as claimed in claim 14 characterised in that the marks on the lower part of the bolt head (24) are visible grooves.

16. A system as claimed in claim 11, wherein the length of the drive-in bolt (32) is selected in such a way that the expansion body (22) is pressed into the expansion sleeve (12) to a predetermined depth to spread apart the expansion tongues (18) and to generate an undercut.
